(19) United States
(12) Patent Application Publication
(10) Pub. No.: US 2009/0065639 A1
(43) Pub. Date: Mar. 12, 2009

(54) Separate Communication Line for Towed Body

(76) Inventor: Nissim Hazan, Kiryat Motzkin (IL)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/918,289

(22) PCT Filed: Apr. 14, 2005
(86) PCT No.: PCT/IL2005/000397

§ 371 Date: Oct. 27, 2008

(51) Int. Cl. B64D 3/00; B65H 75/00

(52) U.S. Cl. 244/1 TD; 242/370

(57) ABSTRACT

The present invention relates to a system for connecting an aircraft to a towed body, which comprises: (a) a reduced towing cable comprising tension filaments to provide the tensional force required for towing the body; (b) a signal cable, separate from said reduced towing cable, for conveying signals between the aircraft and the towed body, said signal cable comprises one or more optical fibers; and (c) conductive wires either within said towing cable or within said signal cable for providing electrical path between the aircraft and the towed body.

### FIELD OF THE INVENTION

This invention relates to means for attaching a towed object to an aircraft and transmitting signals between the object and the aircraft, which means are more economical and more durable than the towing cables presently in use.

### BACKGROUND OF THE INVENTION

Towed objects of various kinds are attached to aircraft by means of towing cables which each comprises three kinds of components having different functions. The first kind is constituted by strong filaments, each will be called hereinafter “tension filaments”, which transmit the force required for towing and overcoming the inevitable aerodynamic drag and weight caused by the towed object and by the towing cable. The tension filaments are typically made of Kevlar, which have the overall cross-section required to withstand the tension generated by the towing force. The second kind of components is constituted by conductive filaments, which transmit power from the aircraft to the towed body. The conductive filaments are typically metal, particularly copper wired, and have such an overall cross-section as to transmit the desired power. The third kind of components is constituted by optical fibers, which serve to the transmittal of signals between the aircraft and the towed body, in one and/or the other direction as the case may be.

These various components are coupled and combined to form a towing cable. The towing cables of the art have various drawbacks. Firstly, they are extremely expensive, in the order of hundreds of dollars for one hundred meters of cable. Secondly, they are ill-adapted to repeated use, to the extent that the manufacturers do not guarantee that they may be used more than once.

It is therefore a purpose of this invention to overcome all the aforesaid drawbacks and provide means for connecting a towed body to an aircraft that are relatively inexpensive and adapted for repeated use.

### SUMMARY OF THE INVENTION

According to the invention, the aircraft is connected to the towed body by two separate cables: (a). a towing cable which comprises the tension filaments, which cable provides the tensional force required for towing the body. Said towing cable will be also referred to hereinafter as “reduced towing cable”; and (b). a signal cable which comprises optical fibers, the function of which is to convey signals between the aircraft and the towed body. The fibers are kept within said signal in a side by side arrangement by any suitable means, preferably by binding them with adhesive or enclosing them within a plastic jacket to form said separate cable. The conductive wires for forming a conductive electrical path between the aircraft and the towed body are bounded within one of said towing or signal cables.

The tension filaments and the conductive wires may be essentially the same as those existing in prior art towing cables. Their function is the same and the required cross-sections are essentially the same. The reduced towing cable is preferably enclosed within a plastic jacket. The optical fibers within the signal cable typically have a diameter of 0.2 mm each, said diameter being determined only by the signals which are to be transmitted by them. The signal cable has no mechanical function and when comprising only the optical fibers typically has a diameter from 0.2 to 0.5 mm.

The optical fibers are preferably made of glass, and the conductive wires of copper. The diameter of the reduced towing cable is typically from 1 to 3 mm.

### BRIEF DESCRIPTION OF THE DRAWINGS

In the drawings:

FIG. 1 schematically illustrates a towing cable according to the prior art;

FIG. 2 is a cross-section of such a cable;

FIG. 3 schematically shows a towing system according to an embodiment of the invention;

FIG. 4 is a cross-section of a towing system according to a first embodiment of the present invention; and

FIG. 5 is a cross-section of a towing system according to a second embodiment of the present invention.

### DETAILED DESCRIPTION OF PREFERRED EMBODIMENTS

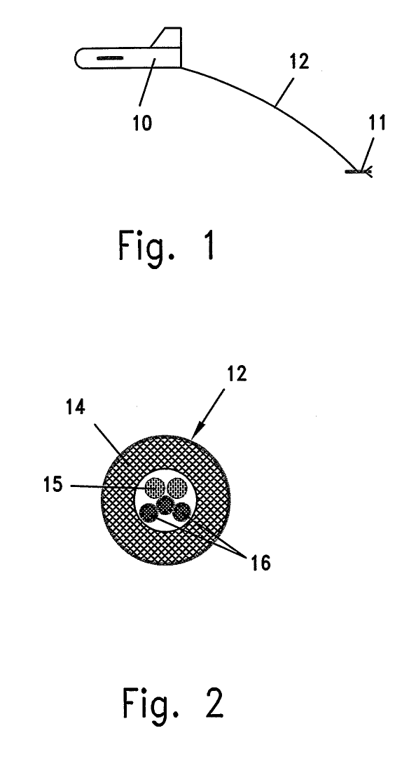

In FIG. 1, numeral 10 schematically indicates a towing aircraft. Numeral 11 schematically indicates a towed body. Numeral 12 generally indicates a towing cable according to the prior art, which comprises the tension filaments (stress bearing fibers), the optical fibers, and the conducting wires. In FIG. 2, which provides a cross-sectional view of the prior art cable of FIG. 1, numeral 14 indicates the tension filaments, which are assumed to be made of Kevlar. Towing cable 12 also includes copper conductive wires 15, which, in a particular prior art embodiment, have a diameter of about 0.7 mm each, and are in the number of 2. Towing cable 12 also comprises optical fibers 16, which, in a particular prior art embodiment, are in the number of 3.

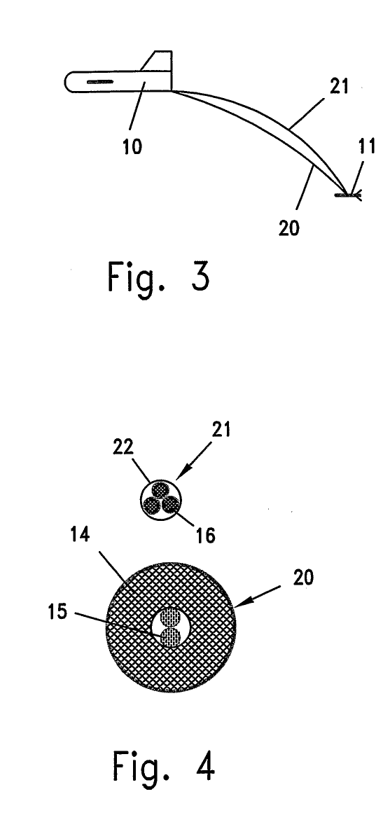

In the embodiment of the invention illustrated in FIGS. 3 and 4, numerals 10 and 11 again indicate the towing aircraft and the towed body respectively. Numeral 20 indicates a reduced towing cable and numeral 21 indicates the signal cable. In a first embodiment of the invention shown in FIG. 4, reduced towing cable 20 may have the same number of tension filaments and conductive filaments as the towing cable 12 of FIG. 2. Signal cable 21, which as shown is a cable which is separate from the towing cable 20, comprises the same number and the same type of optical fibers 16 as included in the towing cable 12 of FIG. 2. Said optical fibers are bounded in a side by side relationship by suitable means, which, in the illustrated embodiment, is a plastic jacket 22, but could e.g. be an adhesive connecting the separate fibers. The diameter of the optical cable, in this embodiment, is approximately 0.5 mm.

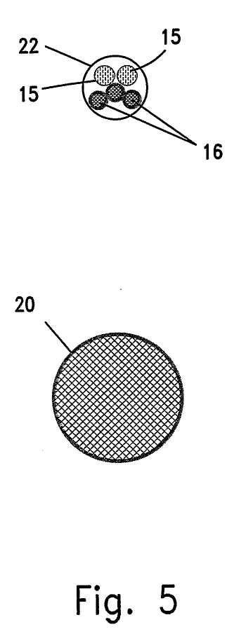

FIG. 5 illustrates still another embodiment of the invention. The towing (reduced) cable of FIG. 5 is made only from the tension filaments, such as those of cable 20 of FIG. 4, and cable 12 of FIG. 2, and essentially in the same number. The signal cable 21 comprises both the optical fibers 16 (although three are shown, the number of fibers may change) and the conductive wires 15. The optical fibers 16 and the conductive wires 15 are bounded by means of jacket 22.

For each meter of reduced towing cable 20, the signal cable 21 has a length of 1.01 to 1.05 meter, viz. the signal cable is longer than the reduced towing cable by about 1 to 5%.

It should be noted that the invention permits to do without certain components that are necessary in prior art apparatus, thereby achieving a simplification of the system and rendering it more economical. The prior art requires means for controlling the winding of the cable, since uncontrolled winding may cause rupture of the optical fibers, and it also requires a brake for the winding drum, to avoid sudden tensional stress of the optical fibers when the cable has reached an end.

Furthermore, the prior art towing cable is released from a drum at the aircraft, which is rotated when the cable is released. Therefore, in order to maintain electric connection between the copper wires and the supplying facility within the aircraft, there is a need to provide slip rings at the drum which ensure continuous connection between the rotated ends of the conductive wires and a stationary port (connector) at the aircraft. Moreover, as the cable of the prior art also comprises optical fibers, an equivalent optical connecting element (optical rotary joint) has also to be provided at the drum in order ensure continuous optical connection between the rotated ends of the fibers and a stationary optical port at the aircraft. It should be noted that the slip rings are relatively expensive, while the optical rotary joint is very expensive, several orders more expensive than of the slip rings. These two elements are also complicated and not so reliable.

According to the present invention the reduced towing cable is released from a drum as in the prior art. The signal cable, however, is released from a stationary conical spool. Therefore, in the first embodiment of the present invention, where the signal cable comprises optical fibers only and is released from a stationary conical spool, the very expensive optical rotary joint is eliminated. The not so expensive slip rings are still necessary for the conductive wires that are included within the reduced cable that is wound on a drum. In the second embodiment of the invention, both the optical fibers and the conductive wires which are included within the signal cable and that are wound on a stationary spool do not need any slip rings or rotary joint. Therefore, the elimination of said two components saves very high costs, and makes the system to be more reliable. Moreover, the signal cables according the two embodiments of the invention become very cheap, so they can be disposable.

While a particular embodiment of the invention has been described for the purpose of illustration, it will be obvious that the invention can be carried out with many modifications, variations and adaptations without exceeding the scope of the claims.

1. System for connecting an aircraft to a towed body, which comprises:
a. a reduced towing cable comprising tension filaments to provide the tensional force required for towing the body;
b. a signal cable, separate from said reduced towing cable, for conveying signals between the aircraft and the towed body, said signal cable comprises one or more optical fibers; and
c. conductive wires either within said towing cable or within said signal cable for providing electrical path between the aircraft and the towed body.

2. System according to claim 1, wherein the optical fibers within the signal cable are held together by adhesive or by being enclosed within a plastic jacket.

3. System according to claim 1, wherein the signal cable has a length of 1.01 to 1.05 meter per meter of the length of the reduced towing cable.

4. System according to claim 1, wherein the reduced towing cable has a diameter from 1 to 3 mm.

5. System according to claim 1, wherein the signal cable has an overall diameter from 0.2 to 0.5 mm.

6. System according to claim 1, wherein the optical fibers are made of glass.

7. System according to claim 1, wherein the conductive wires are made of copper.

8. System according to claim 1, further comprising at the aircraft a rotated drum for the reduced cable and a stationary spool for the signal cable.
